(19) United States
(12) Patent Application Publication
(10) Pub. No.: US 2016/0299066 A1
(43) Pub. Date: Oct. 13, 2016

(54) REFRACTIVE INDEX MEASURING METHOD, REFRACTIVE INDEX MEASURING APPARATUS, AND OPTICAL ELEMENT MANUFACTURING METHOD

(71) Applicant: CANON KABUSHIKI KAISHA, Tokyo (JP)

(72) Inventor: Seima Kato, Utsunomiya-shi (JP)

(21) Appl. No.: 15/089,119

(22) Filed: Apr. 1, 2016

(30) Foreign Application Priority Data
Apr. 8, 2015 (JP) 2015-079471

(51) Int. Cl. G01N 21/41; C03B 11/08

(52) U.S. Cl. CPC G01N 21/4133; C03B 11/08; C03B 2215/46

(57) ABSTRACT

A refractive index measuring method includes measuring a transmitted wavefront of a test object in each of a plurality of arrangements that differ from each other in the position of the test object, estimating a plurality of refractive indices with regard to a reference test object having the same shape as that of the test object, calculating a transmitted wavefront when the reference test object is disposed in each of the plurality of arrangements with regard to each of the plurality of refractive indices, and calculating the refractive index of the test object using the transmitted wavefront of the test object and the transmitted wavefront calculated with regard to the reference test object.

### BACKGROUND OF THE INVENTION

1. Field of the Invention

The present invention relates to a method for measuring a refractive index of an optical element such as a lens, and an apparatus for measuring the refractive index, as well as a method of manufacturing an optical element.

2. Description of the Related Art

In an optical apparatus such as a digital camera or a laser beam printer, an optical element having a complicated shape is sometimes used for the purpose of reducing the aberration of the optical system. Such an optical element having a complicated shape is required to be manufactured efficiently by molding. However, in molding, the refractive index of the optical element changes slightly depending on molding conditions, and therefore desired optical characteristics of the optical element may not be obtained. For this reason, it is necessary to measure the refractive index of the molded optical element with a high degree of accuracy.

U.S. Pat. No. 5,151,752 discloses a conventional method of measuring the refractive index of an optical element. According to U.S. Pat. No. 5,151,752, a glass specimen having a known refractive index and shape and a test lens having an unknown refractive index and a known shape are immersed in matching liquid having substantially the same refractive index as that of the test lens, a beam of light is transmitted through the glass specimen, the transmitted wavefront is measured, and the refractive index of the test lens is thereby measured.

The refractive index measuring method disclosed in U.S. Pat. No. 5,151,752 needs for the glass specimen to be immersed in matching oil having substantially the same refractive index as the refractive index of the test lens. Therefore, when the refractive index of the test lens is high, measurement is performed using matching oil having a high refractive index. However, matching oil having a high refractive index has low transmittance, and therefore the measurement accuracy is prone to decrease.

### SUMMARY OF THE INVENTION

A refractive index measuring method includes measuring a transmitted wavefront of a test object in each of a plurality of arrangements that differ from each other in the position of the test object, estimating a plurality of refractive indices with regard to a reference test object having the same shape as that of the test object, calculating a transmitted wavefront when the reference test object is disposed in each of the plurality of arrangements with regard to each of the plurality of refractive indices, and calculating the refractive index of the test object using the transmitted wavefront of the test object and the transmitted wavefront calculated with regard to the reference test object.

A refractive index measuring apparatus includes a light source, a measuring unit that causes light from the light source to be incident on a test object and measures a transmitted wavefront of the test object, and a calculating unit that calculates a refractive index of the test object using the transmitted wavefront of the test object. The measuring unit measures a transmitted wavefront of the test object in each of a plurality of arrangements that differ from each other in the position of the test object. The calculating unit estimates (approximates) a plurality of refractive indices with regard to a reference test object having the same shape as that of the test object, calculates a transmitted wavefront when the reference test object is disposed in each of the plurality of arrangements with regard to each of the plurality of refractive indices, and calculates the refractive index of the test object using the transmitted wavefront of the test object and the transmitted wavefront calculated with regard to the reference test object.

Further features of the present invention will become apparent from the following description of exemplary embodiments with reference to the attached drawings.

### BRIEF DESCRIPTION OF THE DRAWINGS

FIG. 1 is an illustration diagram of a refractive index measuring apparatus of a first embodiment of the present invention.

FIG. 2 is a flowchart showing the procedure for calculating refractive index in the first embodiment of the present invention.

FIG. 3 is a diagram showing a modification of the refractive index measuring apparatus of the first embodiment of the present invention.

FIG. 4 is a flowchart showing the procedure for calculating refractive index in a second embodiment of the present invention.

FIG. 5 is an illustration diagram of a refractive index measuring apparatus of a third embodiment, of the present invention.

FIG. 6 is a schematic diagram of a shack-Hartman sensor used in the third embodiment of the present invention.

FIG. 7 is a flowchart showing the procedure for calculating refractive index in the third embodiment of the present invention.

FIG. 8 shows a process for manufacturing an optical element using the present invention.

### DESCRIPTION OF THE EMBODIMENTS

Embodiments of the present invention will now be described with reference to the drawings.

### First Embodiment

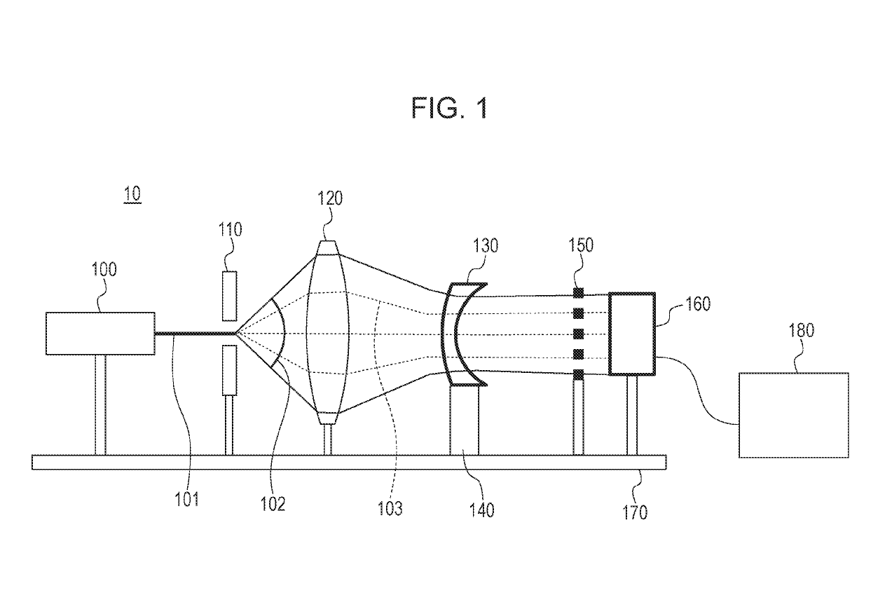

FIG. 1 is an illustration diagram of a refractive index measuring apparatus 10 of a first embodiment of the present invention. The refractive index measuring apparatus 10 causes light 101 from a light source 100 to be incident on a test object 130, and measures the transmitted wavefront of the test object 130 using a detector 160. A calculating unit 180 that is a computer including a CPU (central processing unit) and related circuitry calculates the refractive index of the test object 130 based on the transmitted wavefront measured using the detector 160. In this embodiment, a Talbot interferometer, which is one of the shearing interferometers, is used as a measuring unit that measures the transmitted wavefront of the test object 130.

The light source 100 is a laser light source such as a helium-neon laser. Laser light 101 emitted from the light source 100 along the optical axis is diffracted when passing through a pinhole 110, and thereby becomes diverging light (spherical wave) 102. The diverging light diffracted by the pinhole 110 is converted into converging light 103 by a collimator lens 120. The converging light 103 is transmitted through the test object 130, passes through a diffraction grating 150 that is an orthogonal diffraction grating, and is incident on the detector 160. The detector 160 is an image sensor such as a CCD sensor.

Suppose, in this embodiment, the test object 130 is a lens the shape of which is known, and has no refractive index distribution. The diameter φₚ of the pinhole 110 is so small that diffracted light 102 can be regarded as an ideal spherical wave, and is designed using the object-side numerical aperture (NAG) of the test object 130 and the wavelength λ of the laser light source 100 so as to satisfy the following expression 1.

$${φ}_{p} \approx \frac{λ}{NAO} \qquad ( 1 )$$

For example, when λ is 600 nm and the object-side numerical aperture NAO of the test object 130 is about 0.3, the diameter φₚ of the pinhole 110 may be about 2 μm.

When the image-side NA (numerical aperture) of the test object 130 is small, a spurious resolution of the diffraction grating 150 is obtained as interference fringes on the detector 160 when the distance Z between the diffraction grating 150 and the detector 160 satisfies a Talbot condition expressed by the following expression 2.

$$\frac{{Z}_{0} Z}{{Z}_{0} - Z} = \frac{{md}^{2}}{λ} \qquad ( 2 )$$

Z denotes the distance between the diffraction grating 150 and the detector 160, which will be herein referred to as Talbot distance. m is an integer other than zero, and d is the pitch of the diffraction grating 150. Z₀ is the distance between the diffraction grating 150 and the focal position of light incident on the diffraction grating. The grating pitch d of the diffraction grating 150 is determined according to the magnitude of the aberration of the test object 130.

The test object 130 can be moved by a parallel eccentricity mechanism 140 such as a positioning stage, which is movable in the optical axis direction and a direction perpendicular to the optical axis. The collimator lens 120, the diffraction grating 150, and the detector 160 are movable on a rail 170 installed parallel to the optical axis.

The calculating unit 180 calculates the optimum arrangement of the test object 130, the diffraction grating 150, and the detector 160 according to the refractive power (the reciprocal of the focal length) of the test object 130, and moves the test object 130, the diffraction grating 150, and the detector 160 to the calculated positions. At this time, the test object 130 is moved by the parallel eccentricity mechanism 140, and the diffraction grating 150 and the detector 160 move on the rail 170. Here, the optimum arrangement means a case where light rays passing through the test object 130 are all incident on the detector 160, and the NA of the light rays is small.

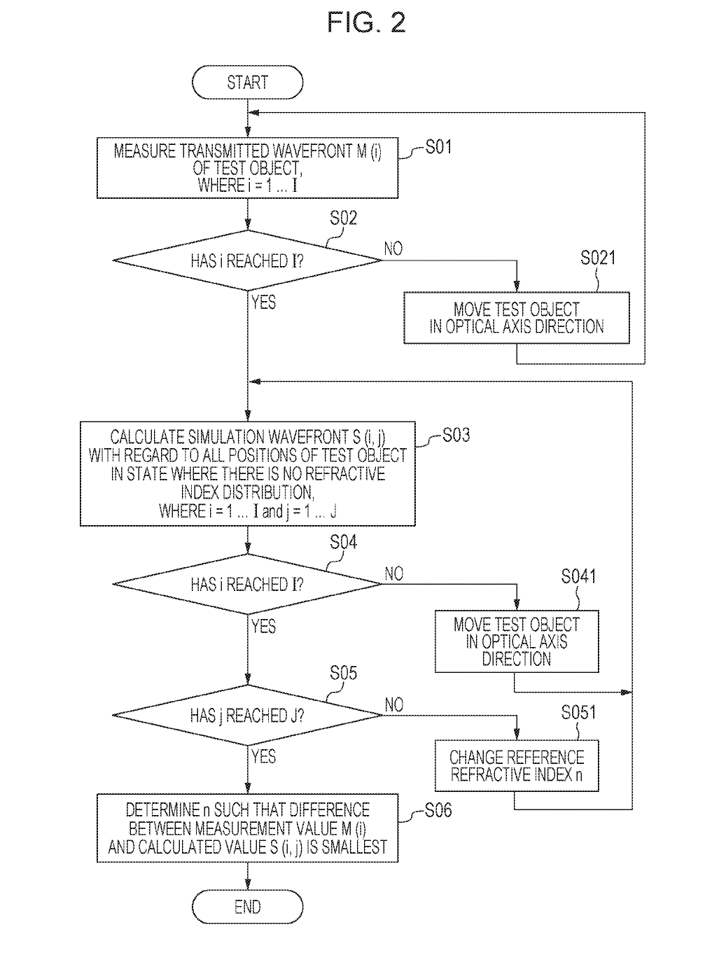

The refractive index of the test object 130 is calculated in the calculating unit 180 according to a computer program. FIG. 2 shows the procedure for calculating the refractive index of the to object 130 using the image of interference fringes taken by the detector 160.

The transmitted wavefront of the test object 130 is measured, with the test object 130, the diffraction grating 150, and the detector 160 disposed at positions suitable for the measurement of the test object 130 (step S01). Next, the process of moving the test object 130 using the parallel eccentricity mechanism 140 in the optical axis direction by a predetermined amount and measuring the transmitted wavefront of the test object 130 is repeated until a specified number of times I (for example, I=10) is reached (steps S02 and S021). The measurement value of the transmitted wavefront obtained for the i-th time (where i=1 to I) as denoted by M(i).

Next, the calculating unit 180 calculates the transmitted wavefront (simulation wavefront) with regard to a reference test object that has the same shape as that of the test object 130 and has a specific refractive index (steps S03, S04, S041, S05 and S051). A specific refractive index (reference refractive index) is estimated with regard to the reference test object, and the transmitted wavefront when the reference test object is disposed in each of the plurality of arrangements of the test object 130 in steps S01, S02 and S021 is calculated (step S04). The simulation wavefront of the reference test object in each of the plurality of arrangements (i=1 to I) in which the transmitted wavefront of the test object is measured is calculated while assuming a plurality of refractive indices as the reference refractive index. The simulation wavefront obtained when the reference refractive index is estimated for the j-th time (where j=1 to J) and the reference test object is disposed in each of the plurality of arrangements (i =1 to I) will be denoted by S(i, j).

As an example, a description will be given of a case where the refractive index of the test object is estimated to 1.85, where it is known that the refractive index of the test object is between 1.80 to 1.90. Therefore, as used herein, the refractive index of the test object is estimated to, for example, an average or mean of known values of the refractive index of the test object.

First, the refractive index of the reference test object (reference refractive index) n is set to 1.80, and the simulation wavefront S(1, 1) when the reference test object is disposed at the same position as that when the transmitted wavefront of the test object 130 is first measured is calculated (step S03).

Next, the calculating unit 180 calculates the simulation wavefront S(2, 1) when the reference test object is moved in the optical axis direction. The same calculation is repeated a specified number of times I (steps S04 and S041).

Next, the reference refractive index n is set to 1.81, and step S03, step S04 and step S041 are repeated. Such calculation is repeated until the reference refractive index n reaches 1.90 (steps S05 and S051). Here, J=11, and the reference refractive index is changed in increments of 0.01.

Finally, a reference refractive index is calculated as the refractive index of the test object so that the difference between the measurement value M(i) of the transmitted wavefront of the test object and the calculated value S(i, j) of the transmitted wavefront of the reference test object is smallest (step S06), and the refractive index measurement is thereby completed.

The measurement value M(i) of the transmitted wavefront of the test object 130 and the calculated value S(i, j) of the transmitted wavefront of the reference test object (simulation wavefront) are two-dimensional wavefronts. The definition of the difference between two-dimensional wavefronts and the method for determining the refractive index will be described below.

First, the RMS (root mean square) of the difference between the measurement value M(i) of the transmitted wavefront of the test object and the calculated value S(i, j) of the transmitted wavefront of the reference test object, which are two-dimensional data sets, is calculated, and is denoted by φ(i, j). Here, the integration range in the expression 3 below shows the data region of two-dimensional data.

$$ϕ ( i , j ) = \sqrt{\frac{\int {\{ M ( i ) - S ( i , j ) \}}^{2} d s}{\int d s}} \qquad ( 3 )$$

Next, the square-root of sum of squares of φ(i, j) is calculated for each arrangement of the test object, and is denoted by Φ(j). Φ will be referred to as merit function.

$$Φ ( j ) = \sqrt{{\sum }_{i = 1}^{I} {\{ ϕ ( i , j ) \}}^{2}} \qquad ( 4 )$$

Next, a variable p when the merit function Φ takes the minimum value Φ(p) is determined. Then, the refractive index n(p) is calculated from the variable p. In this embodiment, n(p)=1.80+(p−1)*0.01. The variable p need not coincide with j which is a discrete value. Thus, the refractive index of the test object 130 can be calculated.

By the refractive index measuring method of this embodiment, the refractive index of the test object 130 can be measured with a high degree of accuracy even when there is an error inherent in the refractive index measuring apparatus for each arrangement of the test object 130. Next, the details thereof will be described.

If the refractive index of the test object 130 is denoted by n(p), the error inherent in the refractive index measuring apparatus is denoted by sys(i), and the wavefront aberration generated when the refractive index is different from n(p) is denoted by ΔS(j), the measurement value M(i) of the transmitted wavefront of the test object and the transmitted wavefront S(i, j) of the reference test object can be expressed by the following expression 5.

M(i)=S(i, p)+sys(i)

ΔS(j)=S(i, j)−S(i, p) (5)

At this time, the merit function Φ is expressed by the following expression 6.

$$\begin{matrix}Φ ( j ) = \sqrt{{\sum }_{i = 1}^{I} {\{ ϕ ( i , j ) \}}^{2}} \\ = \sqrt{{\sum }_{i = 1}^{I} \{ \frac{\int ( {sys ( i )}^{2} - 2 sys ( i ) Δ S ( j ) + Δ {S ( j )}^{2} ) d s}{\int d s} \}}\end{matrix} \qquad ( 6 )$$

When the error sys(i) inherent in the refractive index measuring apparatus is different from the wavefront aberration ΔS(j) generated when the refractive index is different from n(p), and the wavefront varies by number i of sys(i), the following equation of expression 7 holds.

$${\sum }_{i = 1}^{I} \{ \int sys ( i ) Δ S ( j ) d s \} = 0 \qquad ( 7 )$$

Using expression 7, the merit function Φ is expressed by the following expression 8, and the merit function Φ is smallest when j=p. This result shows that even when there is an error sys(i) inherent in the apparatus, the refractive index of the test object 130 can be measured with a high degree of accuracy.

$$Φ ( j ) = \sqrt{{\sum }_{i = 1}^{I} \{ \frac{\int ( {sys ( i )}^{2} + Δ {S ( j )}^{2} ) d s}{\int d s} \}} \\ ∴ min ( Φ ) = Φ ( j = p ) \qquad ( 8 )$$

In order to satisfy expression 7, it is preferable to largely change the arrangement of the test object 130 so that the error inherent in the refractive index measuring apparatus changes largely. By using an arrangement such that only some of the light rays passing through the test object 130 reach the detector 160, the moving amount in the optical axis direction is increased, and the arrangement of the test object 130 can be changed largely. In order to largely change the arrangement of the test object 130, the test object 130 may be moved in a direction other than the optical axis direction. For example, by adding moving in a direction perpendicular to the optical axis and moving in a rotation direction about an axis perpendicular to the optical axis to the moving in the optical axis direction, the error inherent in the apparatus in the arrangement of the test object can be changed largely.

In this embodiment, the number J of reference refractive indices is assumed to be 11. However, by increasing this number in the calculation, the error when determining the variable p can be reduced.

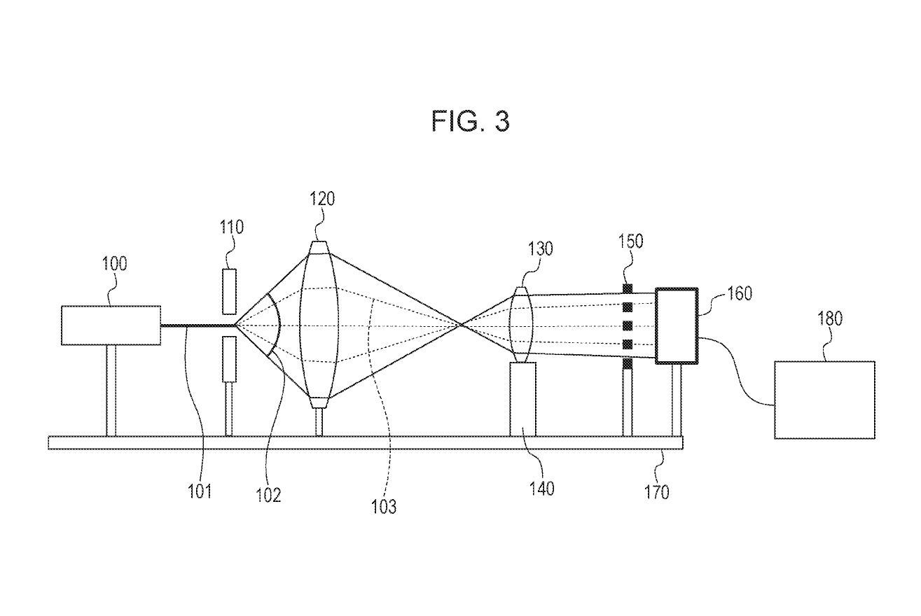

In this embodiment, a description has been given. of a case where the test object 130 is a concave lens having a negative power. However, even when the test object 130 is a convex lens having a positive power, measurement can be performed using the same measuring apparatus. That is, if the test object 130 is disposed on the detector 160 side of the focal point of the collimator lens 120 as shown in FIG. 3, a convex lens can be measured using the same measuring apparatus.

### Second Embodiment

A refractive index measuring apparatus 20 of a second embodiment of the present invention can measure the refractive index of a test object with a high degree of accuracy even when the test object has refractive index distribution. When the test object has refractive index distribution, the refractive index varies depending on the position in the test object. Therefore, in this embodiment, a description will be given assuming that the average refractive index on the optical axis of the refractive index measuring apparatus is the refractive index of the test object. The refractive index measuring apparatus of the second embodiment is a refractive index measuring apparatus that employs a Talbot interferometer as a transmitted wavefront measuring unit. The basic configuration thereof other than the flow of measurement is the same as that of the refractive index measuring apparatus described with reference to FIG. 1 in the first embodiment. In this embodiment, the shape of the test object 130 is assumed to be unknown.

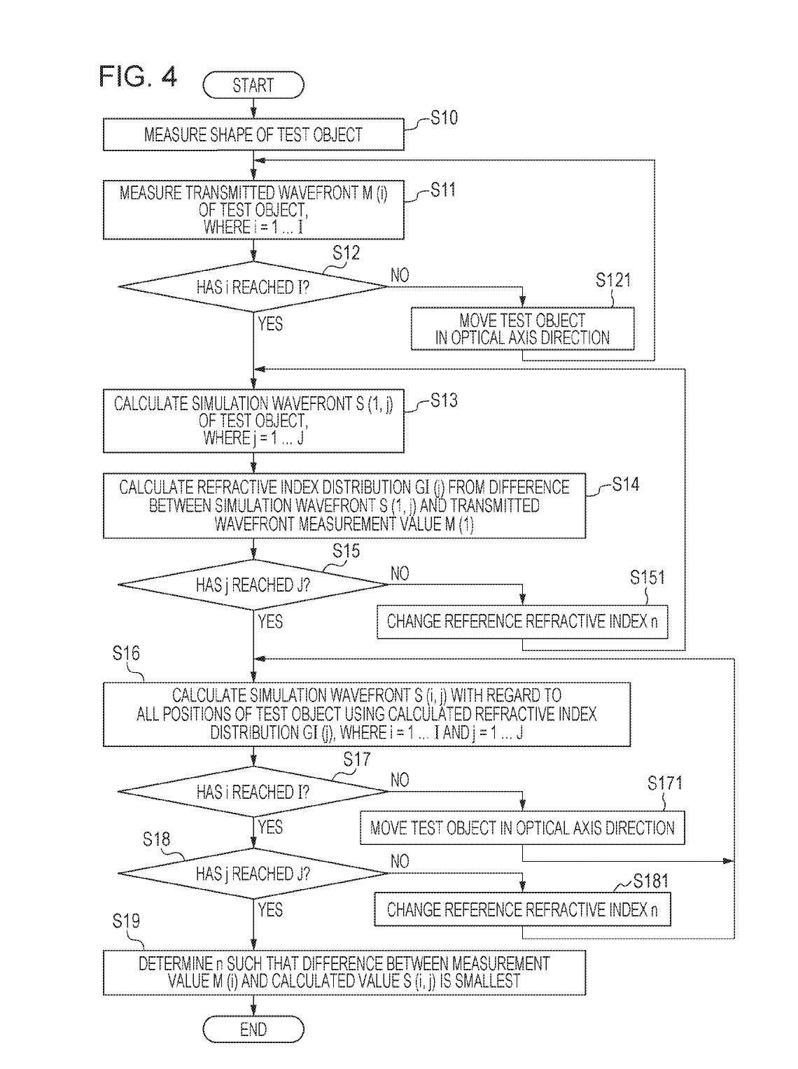

FIG. 4 shows the procedure for calculating the refractive index of a test object when the test object 130 has refractive index distribution. The procedure for calculating the refractive index in the second embodiment will be described below.

First, the shape of the test object 130 is measured (step S10). The shape of the test object 130 is used when calculating the simulation wavefront with regard to a reference test object having the same shape as that of the to object 130 in a subsequent step. The shape of the test object 130 can be measured by a generally known method such as contact-type surface shape measurement or non-contact interference measurement. When the shape of the test object 130 is known, step S10 can be omitted.

In step S11, step S12 and step S121, the transmitted wavefront of the test object 130 is measured while moving the test object in the optical axis direction. As in the first embodiment, the measurement value of the transmitted wavefront measured for the i-th time (i=1 to I) when performing measurement while changing the position of the test object 130 is denoted by M(i).

In step S13, the simulation wavefront S(1, j) when the test object 130 has no refractive index distribution is calculated at any one of the positions where the transmitted wavefront of the test object 130 is measured (for example, the arrangement of the test object 130 when i=1) (step S13). In this embodiment, the reference refractive index used in this calculation is denoted by n(1).

The refractive index distribution GI(j) of the test object 130 is calculated from the difference between the simulation wavefront S(1, j) calculated in step S13 and the measurement value M(1) of the transmitted wavefront of the test object 130 in the same arrangement (i=1) (step S14). The refractive index distribution GI(j) of the test object 130 can be calculated by dividing the difference between the simulation wavefront S(1, j) and the measurement value M(1) of the transmitted wavefront of the test object 130 by the thickness distribution of the test object.

In step S15 and step S151, step S13 and step S14 are repeated while changing the refractive index of the reference test object (reference refractive index) n(j), where j=1 to J.

Next, using the calculated refractive index distribution GI(j), the simulation wavefront S(i, j) of the reference test object is calculated with regard to all the positions of the test object (i=1 to I) and all the reference refractive indices (j=1 to J) (steps S16, S17, S171, S18 and S181). That is, using a plurality of refractive index distributions GI(j) corresponding to respective ones of the plurality of reference refractive indices, the transmitted wavefront S(i, j) when the reference test object is disposed in each of a plurality of arrangements (i=1 to I) is calculated.

The refractive index is calculated so that the difference between the measurement value M(i) of the transmitted wavefront of the test object 130 and the calculated value S(i, j) of the transmitted wavefront of the reference test object is smallest (step S19), and the refractive index measurement in this embodiment is completed.

As described above, by the measurement procedure of the refractive index measuring apparatus of the second embodiment of the present invention, the refractive index of a test object can be measured with a high degree of accuracy even when the test object 130 has refractive index distribution.

### Third Embodiment

A refractive index measuring apparatus 30 of a third embodiment of the present invention can measure the refractive index of a test object 130 with a high degree of accuracy even when the test object 130 has refractive index distribution and the shape of the test object is unknown. The refractive index measuring apparatus 30 of this embodiment measures the transmitted wavefront with the test object 130 disposed in two types of media, thereby separates the shape component and the refractive index distribution of the test object 130, and measures the refractive index of the test object. The refractive index measuring apparatus 30 of this embodiment eliminates the need to separately measure the shape of the test object.

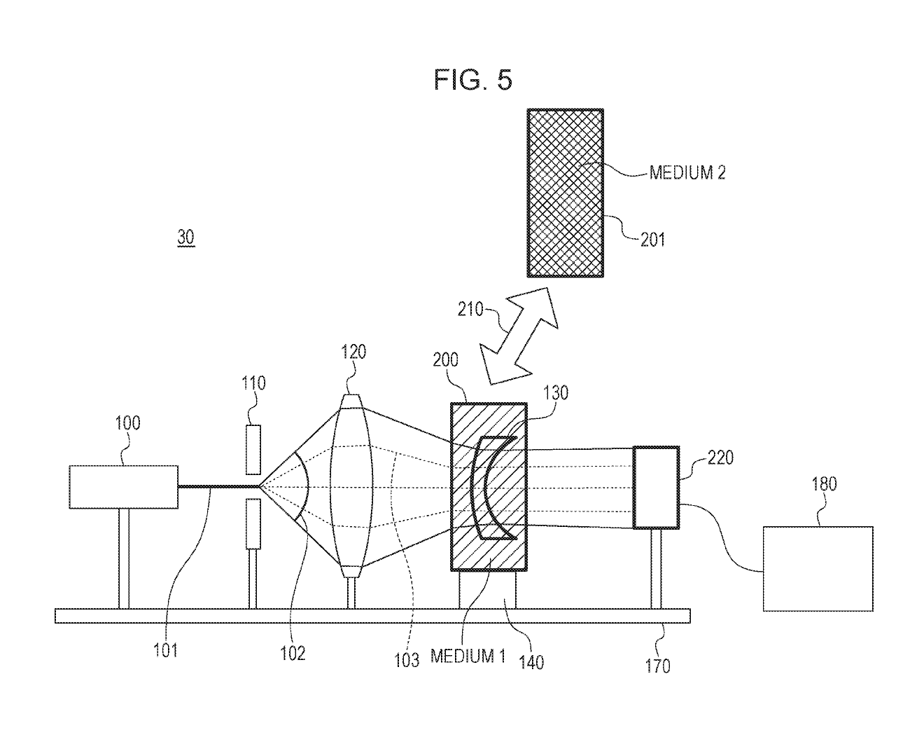

FIG. 5 is an illustration diagram of the refractive index measuring apparatus 30 of the third. embodiment of the present invention. In this embodiment, in order to measure the transmitted wavefront with the test object 130 disposed in two types of media, the refractive index measuring apparatus has a liquid tank 200, a liquid tank 201, and a liquid tank replacing mechanism 210. A shack-Hartman sensor (wavefront sensor) 220 is used as a measuring unit that measures the transmitted wavefront of the test object 130.

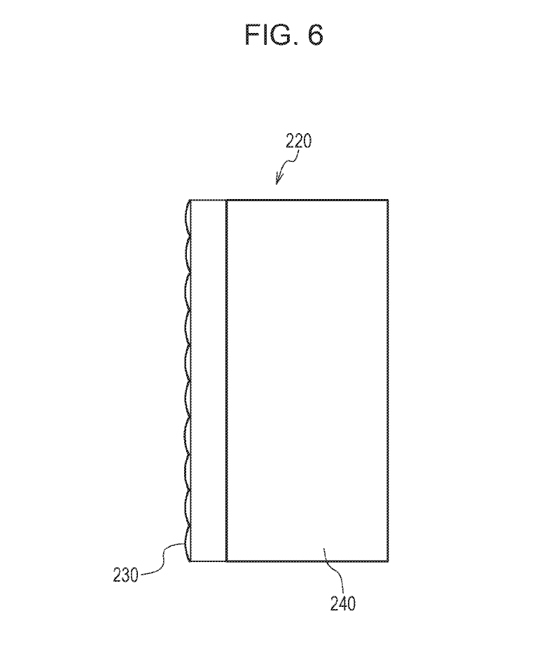

As shown in FIG. 6, the shack-Hartman sensor 220 has a structure in which light incident on a lens array 230 is focused onto an image sensor 240 such as a CCD image sensor or a CMOS image sensor. When an inclined transmitted wavefront is incident on the lens array 230, the positions of focal points are displaced. The shack-Hartman sensor 220 can measure the inclination of the transmitted wavefront as the displacement of focal points, and can therefore measure a wavefront having a large aberration.

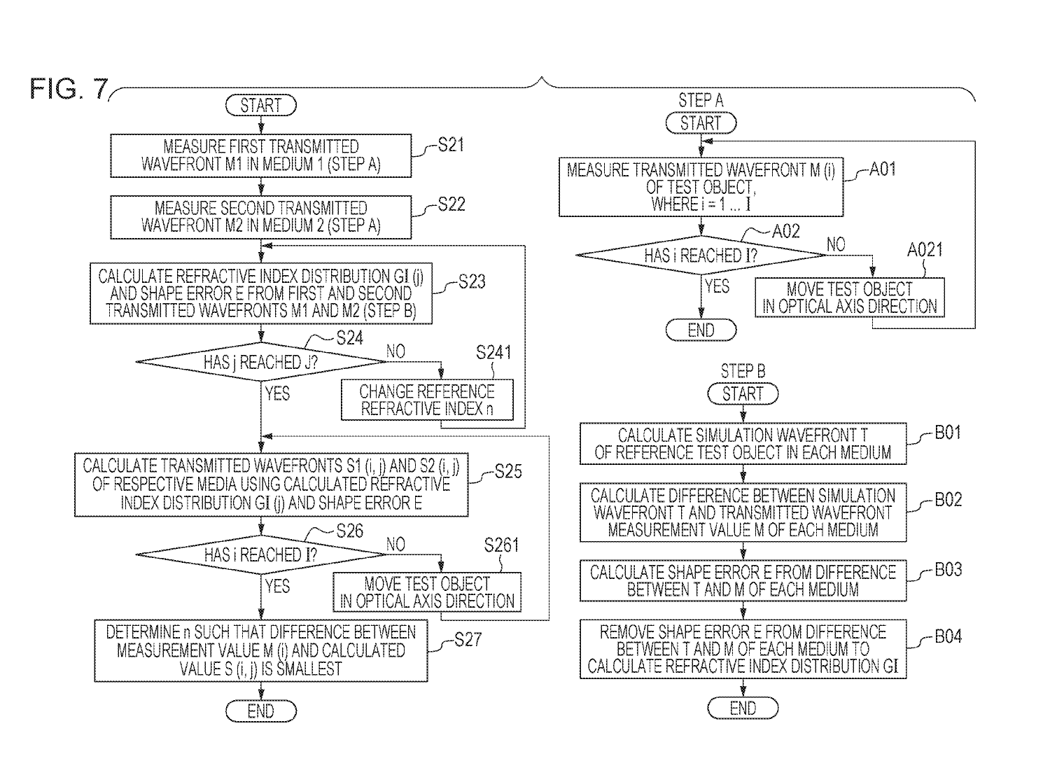

FIG. 7 shows the procedure for calculating the refractive index in this embodiment. The details thereof will be described below.

First, the liquid tank 200 is filled with a medium 1 (for example water), and the test object 130 is disposed in the liquid tank 200. As in the first embodiment, the liquid tank 200 and the wavefront sensor 220 are moved to optimum positions, and a first transmitted wavefront M1 in the medium 1 is measured (step S21). Next, the liquid tank 200 is replaced with the liquid tank 201 using the liquid tank replacing mechanism 210, and the test object 130 is disposed in the liquid tank 201. The liquid tank 201 is filled with a medium 2 (for example oil). As in step S21, the liquid tank 201 and the wavefront sensor 220 are moved to optimum positions, and a second transmitted wavefront M2 in the medium 2 is measured (step S22). In steps S21 and S22, as described in step A, the same measurement as that in steps S01 and S02 in the first embodiment is performed. That is, the transmitted wavefront of the test object 130 is measured while moving the test object 130 in the optical axis direction (steps A01, A02 and A021). The transmitted wavefronts of the test object 130 that are measured for the i-th time while moving the test object 130 with the test object 130 disposed in the medium 1 and medium 2 will be denoted by M1(i) and M2(i), respectively.

Next, the refractive index distribution GI(j) and the shape error E are calculated based on the first transmitted wavefront M1(1) and the second transmitted wavefront M2(1) (step S23).

Step S23 will be described as step B in detail. Step B consists of the following four steps. First, the simulation wavefront T when a reference test object that has the same shape as that of the test object 130 and has no refractive index distribution is disposed in each of the medium 1 and the medium 2 is calculated (step B01). Next, the difference between the simulation wavefront T when the reference test object is disposed in each of the medium 1 and the medium 2 and the measurement value M of the transmitted wavefront of the test object 130 is calculated (step B02). The shape error E of the test object 130 is calculated from the difference between the simulation wavefront T and the measurement value M of the transmitted wavefront of the test object 130 calculated in step B02 (step B03). The shape error E corresponds to the difference between the shape when the test object 130 is ideal (the shape of the reference test object) and the shape of the actual test object 130. Next, the shape error E is removed from the difference between the simulation wavefront T when the reference test object is disposed in each of the medium 1 and the medium 2 and the measurement value M of the transmitted wavefront of the test object 130 to calculate the refractive index distribution GI (step B04).

Then, the refractive index distribution GI(j) and the shape error E(j) are calculated from the transmitted wavefronts M1(1) and M2(1) and the reference refractive index n(j) while changing the reference refractive index n(j) (steps S24 and S241).

Step B will be described below using expressions. The measurement value B of the transmitted wavefront of the test object 130 and the simulation wavefront T of the reference test object can be expressed by the following expressions 9.

M1=GI×D+system1

T1=N(j)(D−E)+N1×E+system1

M2=GI×D+system2

T2=N(j)(D−E)+N2×E+system2 (9)

D denotes the shape of the test object, N1 denotes the refractive index of the medium 1, N2 denotes the refractive index of the medium 2, system1 denotes the wavefront aberration inherent in the measuring apparatus during the measurement of the medium 1, and system2 denotes the wavefront aberration inherent in the measuring apparatus during the measurement of the medium 2. In step B01, T1 and T2 of expression 9 are calculated. In step B03, the shape error E is calculated using the following expression 10.

$$E = \frac{( M 1 - T 1 ) - ( M 2 - T 2 )}{N 2 - N 1} \qquad ( 10 )$$

In step B04, the refractive index distribution GI is calculated using the following expression 11.

$$GI = \frac{( N ( j ) - N 1 ) ( M 2 - T 2 ) - ( N ( j ) - N 2 ) ( M 1 - T 1 )}{( N 2 - N 1 ) D} + N ( j ) \qquad ( 11 )$$

The refractive index distribution GI varies depending on the reference refractive index n(j), and can therefore be denoted by GI(j).

In step S25, the transmitted wavefront (simulation wavefront) S(i, j) when the reference test object is disposed in each of the medium 1 and the medium 2 is calculated using the refractive index distribution GI(j) and the shape error E(j) calculated in steps S24 and S241. At this time, the reference test object is moved in the optical axis direction and the transmitted wavefront is calculated with regard to all positions i (steps S26 and S261), and the transmitted wavefronts S1(i, j) and S2(i, j) of the reference test object in each of the medium 1 and the medium 2 are thereby obtained.

Finally, a refractive index is determined so that the difference between the measurement value M(i) of the transmitted wavefront of the test object 130 and the calculated value S(i, j) of the transmitted wavefront of the reference test object is smallest (step S27). In step S27, the same calculation as that of step S06 of the first embodiment is performed.

In this embodiment, the first transmitted wavefront in the medium 1 having the first refractive index is measured with regard to a plurality of arrangements that differ from each other in the position of the test object. Next, the second transmitted wavefront in the medium 2 having the second refractive index different from the first refractive index is measured with regard to the plurality of arrangements that differ from each other in the position of the test object. The refractive index distribution and the shape error (shape component) of the test object with regard to a plurality of reference refractive indices are calculated from the measurement result of the first and second transmitted wavefronts. The transmitted wavefront when the reference test object having the same shape as that of the test object is disposed at the same position as that of the test object in each of the medium 1 and the medium 2 is calculated using the shape component of the test object, with regard to a plurality of refractive index distributions. By calculating the difference between the measurement value of the transmitted wavefront of the test object and the calculated value of the transmitted wavefront of the reference test object, the refractive index of the test object can be calculated.

By this procedure, the refractive index of the test object can be measured with a high degree of accuracy even when the test object has refractive index distribution and the accurate shape of the test object is unknown.

### Fourth Embodiment

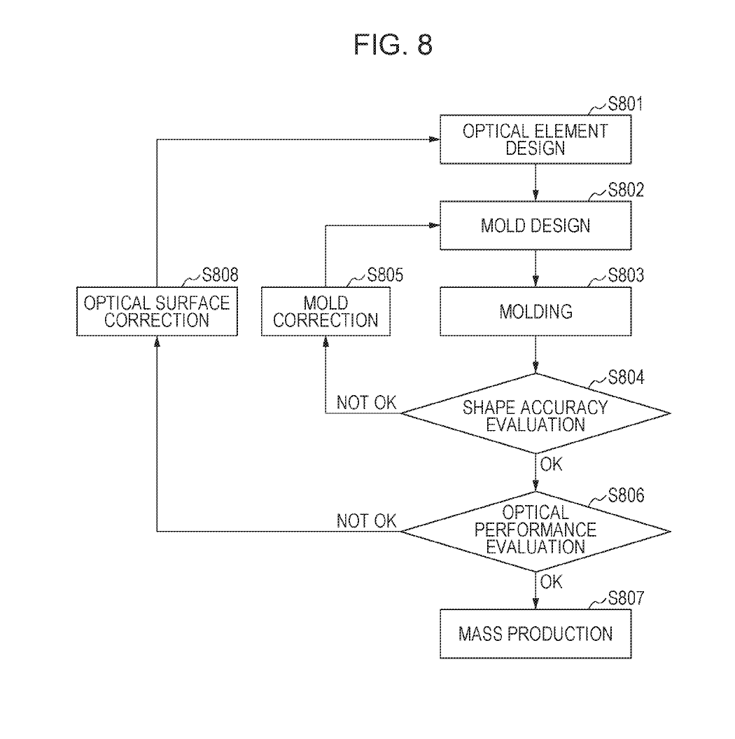

FIG. 8 shows an example of the process for manufacturing an optical element using molding.

The optical element is manufactured through a process for designing the optical element (S801), a process for designing a mold (S802), and a process for molding the optical element using the designed mold (S803). The shape accuracy of the molded optical element is evaluated at S804. If the accuracy is insufficient (not OK at S804), the mold is corrected (S805) and molding is performed once again. If the shape accuracy is sufficient (OK at S804), the optical performance of the optical element is evaluated at S806. Incorporating the refractive index measurement of the present invention into this process for evaluating if the optical performance is OK (OK at S806), the process enables the mass production of an optical element (S807) that is molded using a high-refractive-index glass material as the base material. If the optical performance is low (not OK at S806), the optical element is redesigned by correcting the optical surface (S808).

The above-described embodiments are only representative examples. In the practice of the present invention, various changes and modifications may be made in the embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-079471, filed Apr. 8, 2015, which is hereby incorporated by reference herein in its entirety.

What is claimed is:

1. A refractive index measuring method comprising:
measuring a transmitted wavefront of a test object in each of a plurality of arrangements that differ from each other in the position of the test object;
estimating a plurality of refractive indices with regard to a reference test object having the same shape as that of the test object;
calculating a transmitted wavefront when the reference test object is disposed in each of the plurality of arrangements with regard to each of the plurality of refractive indices; and
calculating the refractive index of the test object using the transmitted wavefront of the test object and the transmitted wavefront calculated with regard to the reference test object.

2. The refractive index measuring method according to claim 1, wherein a plurality of refractive index distributions corresponding to respective ones of the plurality of refractive indices are calculated using the transmitted wavefront of the test object and the transmitted wavefront of the reference test object calculated with regard to each of the plurality of refractive indices, and
the transmitted wavefront when the reference test object is disposed in each of the plurality of arrangements is calculated using the plurality of refractive index distributions corresponding to respective ones of the plurality of refractive indices.

3. The refractive index measuring method according to claim 2, wherein the plurality of refractive index distributions are calculated with regard to some of the plurality of arrangements.

4. The refractive index measuring method according to claim 1, wherein the transmitted wavefront of the test object disposed in a first medium having a first refractive index and the transmitted wavefront of the test object disposed in a second medium having a second refractive index different from the first refractive index are calculated,
the transmitted wavefront of the reference test object when the reference test object is disposed in the first medium and the transmitted wavefront of the reference test object when the reference test object is disposed in the second medium are calculated,
the refractive index distribution and the shape error of the test object are calculated using the transmitted wavefront of the test object disposed in the first and second media and the transmitted wavefront of the reference test object when the reference test object is disposed in the first and second media, and
the transmitted wavefront when the reference test object is disposed in each of the plurality of arrangements in the first and second media is calculated using a plurality of refractive index distributions and the shape error corresponding to respective ones of the plurality of refractive indices.

5. A refractive index measuring apparatus comprising:
a light source;
a measuring unit that causes light from the light source to be incident on a test object and measures a transmitted wavefront of the test object; and
a calculating unit that calculates a refractive index of the test object using the transmitted wavefront of the test object,
wherein the measuring unit measures a transmitted wavefront of the test object in each of a plurality of arrangements that differ from each other in the position of the test object, and
the calculating unit estimates a plurality of refractive indices with regard to a reference test object having the same shape as that of the test object, calculates a transmitted wavefront when the reference test object is disposed in each of the plurality of arrangements with regard to each of the plurality of refractive indices, and calculates the refractive index of the test object using the transmitted wavefront of the test object and the transmitted wavefront calculated with regard to the reference test object.

6. The refractive index measuring apparatus according to claim 5, wherein the calculating unit calculates a plurality of refractive index distributions corresponding to respective ones of the plurality of refractive indices using the transmitted wavefront of the test object and the transmitted wavefront of the reference test object calculated with regard to each of the plurality of refractive indices, and calculates the transmitted wavefront when the reference test object is disposed in each of the plurality of arrangements using the plurality of refractive index distributions corresponding to respective ones of the plurality of refractive indices.

7. The refractive index measuring apparatus according to claim 6, wherein the calculating unit calculates the plurality of refractive index distributions with regard to some of the plurality of arrangements.

8. The refractive index measuring apparatus according to claim 5, wherein the measuring unit measures the transmitted wavefront of the test object disposed in a first medium having a first refractive index and the transmitted wavefront of the test object disposed in a second medium having a second refractive index different from the first refractive index, and
the calculating unit calculates the transmitted wavefront of the reference test object when the reference test object is disposed in the first medium and the transmitted wavefront of the reference test object when the reference test object is disposed in the second medium, calculates the refractive index distribution and the shape error of the test object using the transmitted wavefront of the test object disposed in the first and second media and the transmitted wavefront of the reference test object when the reference test object is disposed in the first and second media, and calculates the transmitted wavefront when the reference test object is disposed in each of the plurality of arrangements in the first and second media using a plurality of refractive index distributions and the shape error corresponding to respective ones of the plurality of refractive indices.

9. The refractive index measuring apparatus according to claim 5, wherein the measuring unit has a shearing interferometer.

10. The refractive index measuring apparatus according to claim 5, wherein the measuring unit has a shack-Hartman sensor.

11. An optical element manufacturing method comprising:
molding an optical element;
measuring a refractive index of the optical element; and
thereby evaluating an optical performance of the optical element,
wherein the refractive index of the optical element is measured by a refractive index measuring method comprising:
measuring a transmitted wavefront of a test object in each of a plurality of arrangements that differ from each other in the position of the test object;
estimating a plurality of refractive indices with regard to a reference test object having the same shape as that of the test object;
calculating a transmitted wavefront when the reference test object is disposed in each of the plurality of arrangements with regard to each of the plurality of refractive indices; and
calculating the refractive index of the test object using the transmitted wavefront of the test object and the transmitted wavefront calculated with regard to the reference test object.
